(19) United States
(12) Patent Application Publication
(10) Pub. No.: US 2015/0253970 A1
(43) Pub. Date: Sep. 10, 2015

(54) METHOD, APPARATUS AND STORAGE MEDIUM FOR ADJUSTING FILTER LIST

(71) Applicant: Tencent Technology (Shenzhen) Company Limited, Shenzhen (CN)

(72) Inventors: Fei CHENG, Shenzhen (CN); Shizhu HUANG, Shenzhen (CN); Feiyun LI, Shenzhen (CN)

(21) Appl. No.: 14/720,616

(22) Filed: May 22, 2015

Related U.S. Application Data
(63) Continuation of application No. PCT/CN2013/087751, filed on Nov. 25, 2013.

(30) Foreign Application Priority Data
Nov. 26, 2012 (CN) 201210486598.0

(51) Int. Cl. G06F 3/0484; G06F 3/0482; G06F 3/0486; G06F 3/0481

(52) U.S. Cl. CPC G06F 3/04845; G06F 3/04842; G06F 3/04817; G06F 3/0482; G06F 3/0486

(57) ABSTRACT

The present disclosure provides an image filter list adjusting method and apparatus. The method includes: detecting a triggering and moving event of a first image filter icon in an image filter list on the touchscreen, triggering a draggable state of the first image filter icon based on the triggering and moving event and enlarging the first image filter icon such that it is larger than other icons in the image filter list; detecting a dragging event of the first image filter icon, dynamically updating locations of the enlarged first image filter icon on the touchscreen, and recording a location of the first image filter icon when the dragging event is completed; and adjusting arrangement of the image filter list according to the location of the first image filter icon when the dragging event is completed and restoring the enlarged first image filter icon to its original size.

### RELATED APPLICATIONS

This application is a continuation application of PCT Patent Application No. PCT/CN2013/087751, entitled “METHOD, APPARATUS AND STORAGE MEDIUM FOR ADJUSTING FILTER LIST” filed on Nov. 25, 2013, which claims priority to Chinese Patent Application No. 201210486598.0, filed with the Chinese Patent Office on Nov. 26, 2012 and entitled “METHOD, APPARATUS AND STORAGE MEDIUM FOR ADJUSTING FILTER LIST”, both of which are incorporated by reference in their entirety.

### FIELD OF THE TECHNOLOGY

The present disclosure relates to the field of image processing technologies, and in particular, to method, apparatus and storage medium for adjusting an image filter list.

### BACKGROUND OF THE DISCLOSURE

With continuous development and popularity of camera applications on a mobile terminal such as a mobile phone and a tablet, more and more users take wonderful pictures by using mobile terminals to record and share various aspects of life. Meanwhile, photo taking and editing software related to camera applications becomes more powerful, and users can use various convenient image processing functions of the software to obtain better pictures.

Filters gain great popularity among users as an image processing function that can realize a certain special effect directly. By using a filter, a user can easily process a plain picture into more than ten kinds of or even dozens of different styles such as a soft light style, a retro style, a sketch style, an oil painting style, a black-and-white style, so as to express different emotions. However, picture styles favored by a user are usually limited to several kinds, while the user often has to traverse all filters to find the frequently used filters, which greatly lowers image processing efficiency.

### SUMMARY

Embodiments of the present invention provide an image filter list adjusting method, which solves a problem of low image processing efficiency that is caused by current fixed arrangement of an image filter list.

An embodiment of the present invention provides an image filter list adjusting method, including: detecting a triggering and moving event of a first image filter icon in an image filter list, and triggering a draggable state of the first image filter icon based on the triggering and moving event; detecting a dragging event of the first image filter icon, and recording a location of the first image filter icon when the dragging event is completed; and adjusting arrangement of the image filter list according to the location of the first image filter icon when the dragging event is completed.

An embodiment of the present invention further provides an image filter list adjusting apparatus, including: a detecting unit, configured to detect a triggering and moving event of a first image filter icon in an image filter list, and trigger a draggable state of the first image filter icon based on the triggering and moving event; a recording unit, configured to detect a dragging event of the first image filter icon, and record a location of the first image filter icon when the dragging event is completed; and an adjusting unit, configured to adjust arrangement of the image filter list according to the location of the first image filter icon when the dragging event is completed.

In the embodiments of the present invention, a location of an image filter icon in the image filter list is changed by detecting a dragging event of the image filter icon in an image processing interface, so as to reset arrangement of the image filter list, and display image filter icons that are frequently used by a user in the front of the image filter list, which improves picture processing efficiency.

### BRIEF DESCRIPTION OF THE DRAWINGS

FIG. 1 is a flowchart of an image filter list adjusting method according to an embodiment of the present invention;

FIG. 2 is a schematic diagram of an example of an image filter list according to an embodiment of the present invention;

FIG. 3 is a schematic diagram of an example of triggering a dragging event of a first image filter icon in an image filter list according to an embodiment of the present invention;

FIG. 4 is a schematic diagram of an example of a dragging event of a first image filter icon in an image filter list according to an embodiment of the present invention;

FIG. 5 is a specific flowchart of implementing an image filter list adjusting method according to an embodiment of the present invention; and

FIG. 6 is a structural block diagram of an image filter list adjusting apparatus according to an embodiment of the present invention.

### DESCRIPTION OF EMBODIMENTS

To make technical solutions and advantages of the present disclosure clearer, the present disclosure is described in further detail with reference to the accompanying drawings and the embodiments. It should be understood that, the specific embodiments described here are merely intended to explain the present invention, but are not intended to limit the present invention.

In the embodiments of the present invention, a location of an image filter icon in an image filter list is changed by detecting a dragging event of the image filter icon in an image processing interface, so as to reset arrangement of the image filter list, and display image filter icons that are frequently used by a user in the front of the image filter list, which improves picture processing efficiency.

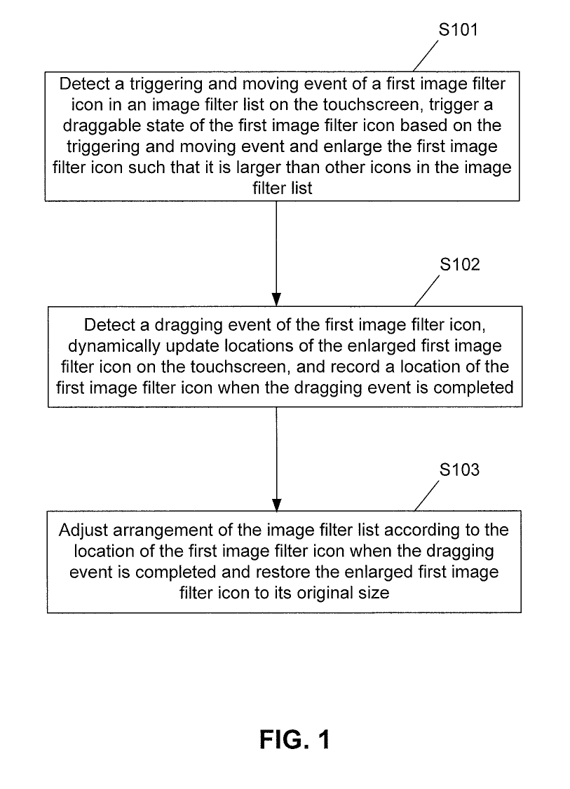

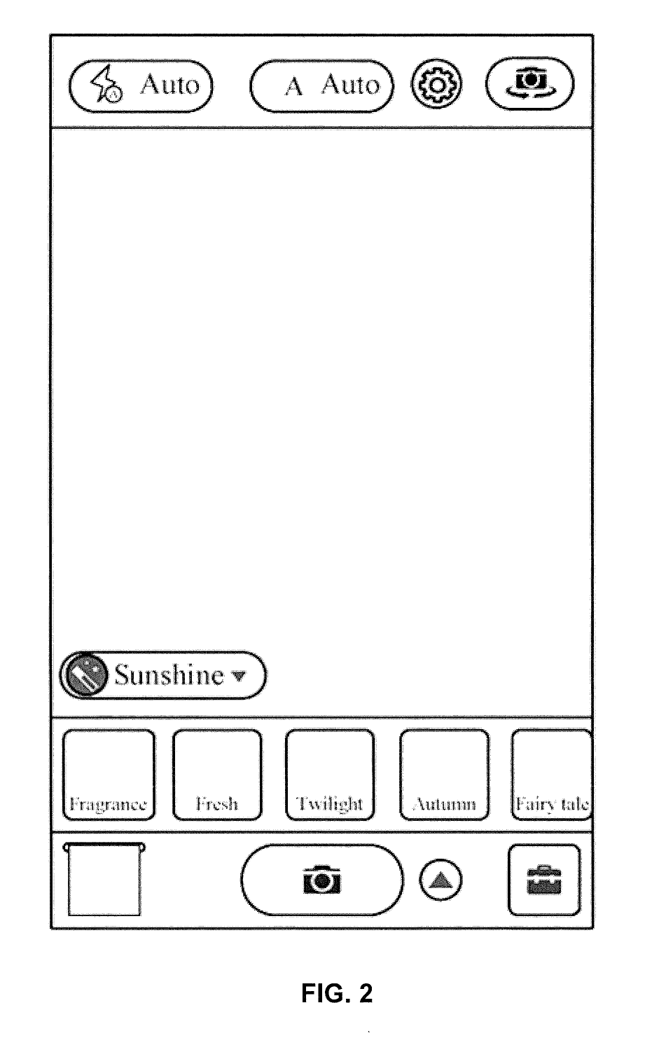

FIG. 1 is a flowchart of an image filter list adjusting method according to an embodiment of the present invention. In this embodiment, the image filter list is located in an image processing interface, where the image processing interface may be an image processing interface in camera software or picture editing software running on a smart terminal device such as a computer, a smartphone, and a tablet. Different image filter icons are shown in the image filter list of the image processing interface, and each image filter icon corresponds to a filter. A user can traverse all image filter icons by sliding the image filter list. Further, as shown in FIG. 2, in an image filter list under an interface, each image filter icon displays an effect of processing a same system default picture by using the corresponding filter, so that a user can know the style of each filter intuitively. The system automatically performs filter processing on a current picture that the user wants to load by detecting a click event of an image filter icon by the user, so as to realize a corresponding picture style.

Still referring to FIG. 1, in step S101, a system using the image filter list adjusting method according to the present disclosure, specifically a detecting unit 61 in the system that is described in the following, detects a triggering and moving event of a first image filter icon in an image filter list on the touchscreen, triggers a draggable state of the first image filter icon based on the triggering and moving event and enlarges the first image filter icon such that it is larger than other icons in the image filter list. The first image filter icon is any icon that a user wants to change a location thereof among all image filter icons that the user can traverse.

The triggering and moving event may be a long press event, a double tap event, or a preset touch track event, which is not limited herein.

In this embodiment, the triggering and moving event of the first image filter icon is detected by using a touchscreen sensing apparatus or a mouse event detecting apparatus. Take the triggering and moving event being a long press event as an example. When the detecting unit 61 detects that lasting time of a touch motion on an image filter icon is longer than a preset threshold, the long press event becomes effective, so as to determine that the triggering and moving event of the first image filter icon is detected. The preset threshold of the lasting time is preset by the system; and as an implementation example of the present disclosure, the preset threshold can be set to 0.5 second or 1 second.

In actual application, when the triggering and moving event becomes effective, a prompt may be given through vibrating feedback of a terminal or an animation event in the image processing interface, so as to inform the user that a triggering and moving event is effective.

After the triggering and moving event becomes effective, a draggable state of the first image filter icon is triggered. Preferably, the first image filter icon in the draggable state is magnified, has its color changed or is displayed in a deformed manner, so that the image filter icon currently in the draggable state is prompted to the user intuitively.

In the draggable state, when a mouse cursor is above the first image filter icon and in a click state, or when a finger is put on the first image filter icon and in a touch state, a dragging track of the first image filter icon is imitated according to a sliding direction of the mouse or the finger, and the first image filter icon can be dragged to any location of the image processing interface.

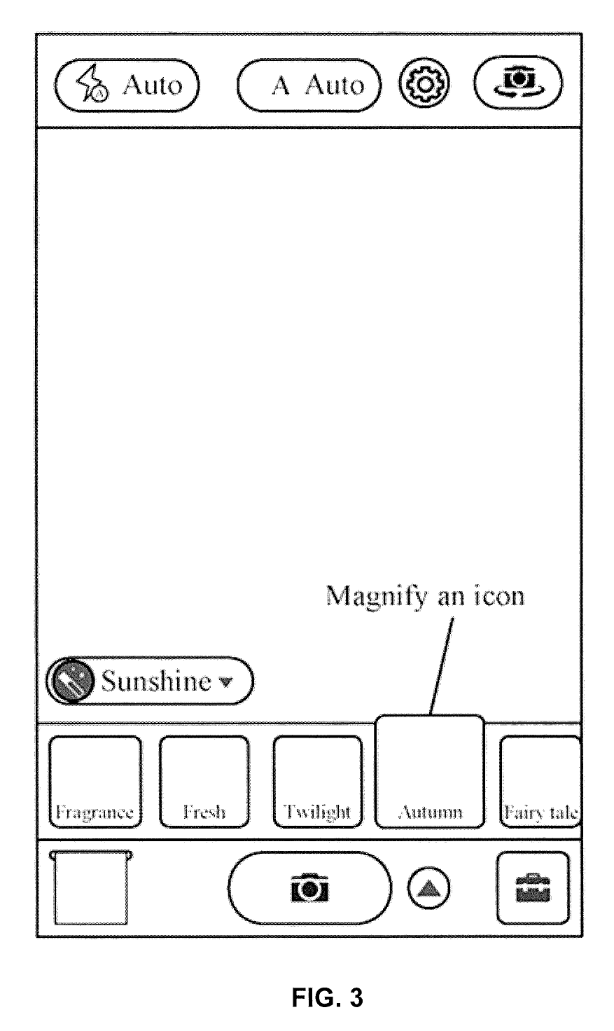

FIG. 3 is a schematic diagram of an example of triggering a dragging event of a first image filter icon in an image filter list according to an embodiment of the present invention. As shown in FIG. 3, the displayed first image filter icon in a draggable state is magnified such that it is larger than other filter icons in the image filter list.

In step S102, the system using the image filter list adjusting method according to the present disclosure, specifically the detecting unit 61 in the system that is described in the following, detects a dragging event of the first image filter icon, and records a location of the first image filter icon when the dragging event is completed.

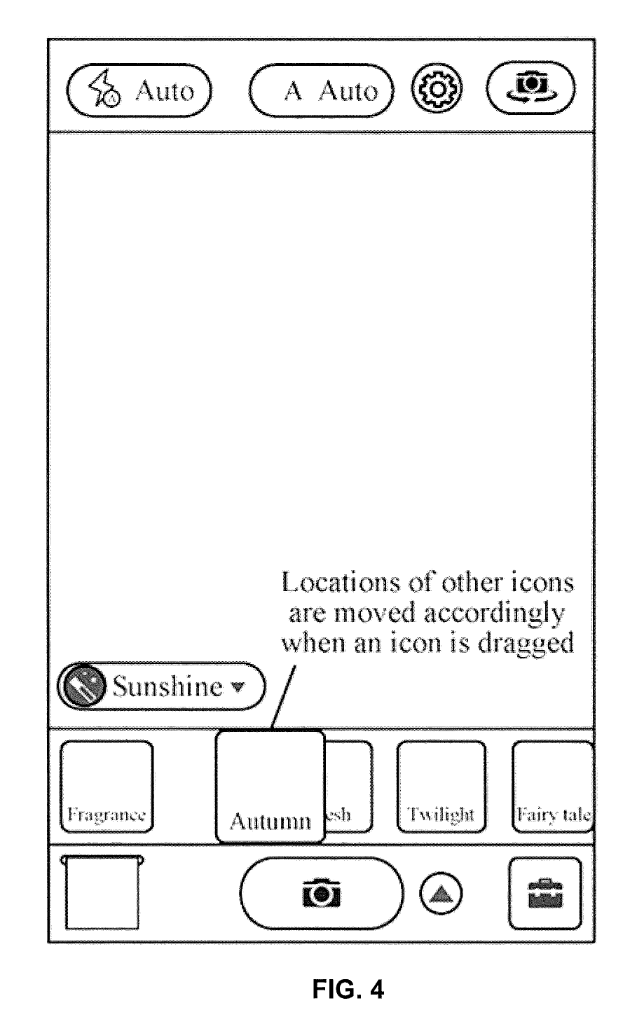

FIG. 4 is a schematic diagram of an example of a dragging event of a first image filter icon in an image filter list according to an embodiment of the present invention. During a process of the dragging event of the first image filter icon, if the first image filter icon is dragged to a location in front of an image filter icon other than the first image filter icon in the image filter list, as shown in FIG. 4, the image filter icon and all other image filter icons following the image filter icon are moved backward sequentially.

In this embodiment, when a mouse or a finger stops a hold motion during the process of the dragging event, it indicates that the dragging event is completed, and then a recording unit 62 records a location of the first image filter icon when the dragging event is completed by obtaining coordinates of the first image filter icon on a screen.

Afterwards, in step S103, the system using the image filter list adjusting method according to the present disclosure, specifically an adjusting unit 63 in the system that is described in the following, adjusts arrangement of the image filter list according to the location of the first image filter icon when the dragging event is completed.

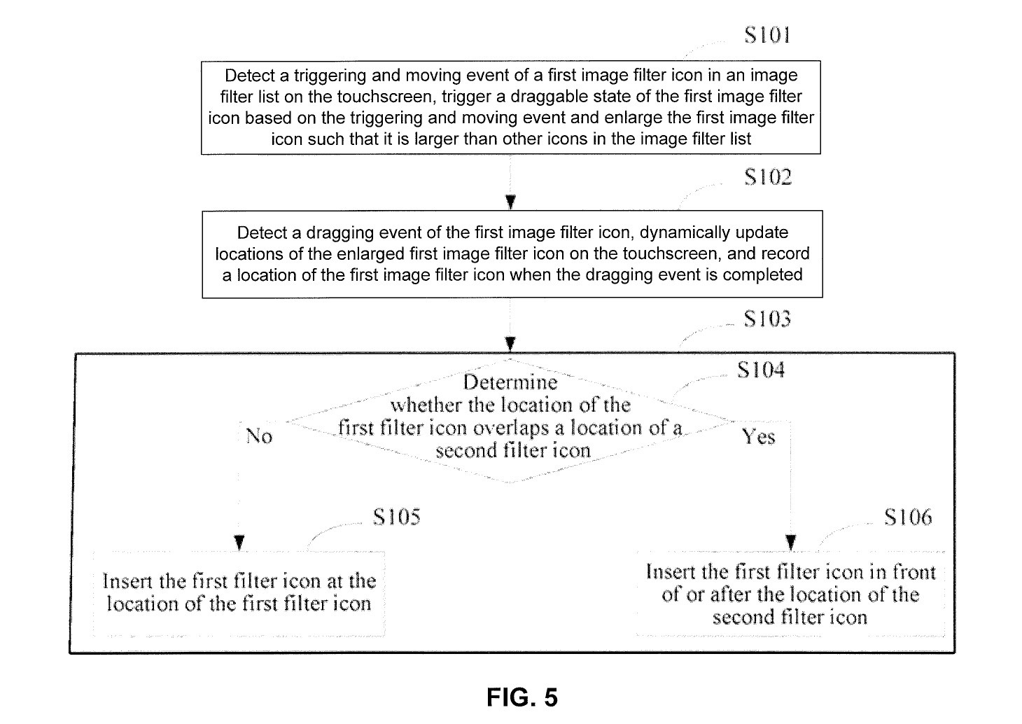

FIG. 5 is a specific flowchart of implementing an image filter list adjusting method according to an embodiment of the present invention. In the embodiment of the present invention, specifically, arrangement of the image filter list is adjusted according to whether a location of a first image filter icon is in an area in which the image filter list locates when a dragging event is completed. As shown in FIG. 5, if a current location of the first image filter icon is in the area in which the image filter list locates, step S103 specifically includes:

In step S104, it is determined whether the location of the first image filter icon overlaps a location of a second image filter icon; if yes, step S106 is performed; otherwise, step S105 is performed.

Based on determination in step S104, in step S105, if the location of the first image filter icon does not overlap the location of the second image filter icon, the first image filter icon is inserted at the location of the first image filter icon directly. If the first image filter icon is inserted at the location of the first image filter icon directly, locations of other image filter icons following the location of the first image filter icon are moved backward sequentially.

Based on determination step S104, in step S106, if the location of the first image filter icon overlaps the location of the second image filter icon, the first image filter icon is inserted in front of or after the location of the second image filter icon. If the first image filter icon is inserted in front of the location of the second image filter icon, the second image filter icon and other image filter icons following the second image filter icon are moved backward sequentially. If the first image filter icon is inserted after the location of the second image filter icon, other image filter icons following the second icon are moved backward sequentially.

By using the foregoing method, arrangement of image filter icons in the image filter list can be adjusted; and as shown in FIG. 4, a filter that is preferred and frequently used by a user A is “Autumn”, but the filter “Autumn” is located at the end of the image filter list, so that the user A usually needs to perform several times of sliding operations on the image filter list to select the filter. By using the foregoing method, the user A can adjust the image filter icon “Autumn” so that the image filter icon “Autumn” is displayed in the first few locations in the image filter list through a dragging motion. In this way, the user can select the filter “Autumn” on a first page of the image filter list so as to beautify a picture, and the user no longer needs to perform sliding operations on the image filter list repeatedly, which makes a displaying manner of the image filter list better satisfies using preference of users, and improves image processing efficiency.

As another embodiment of the present invention, if a location of a first image filter icon is not in an area in which an image filter list locates, a dragging event of the first image filter icon becomes ineffective, and the current an image filter list is maintained and arrangement thereof remains same.

By using the foregoing method, a situation in which a current arrangement manner of the image filter list is changed because of misoperation of a user can be prevented. For example, as shown is FIG. 4, the user A touches an image filter icon of “Autumn” in an image processing interface unintentionally, so that a dragging operation is generated; meanwhile, the user A realizes the misoperation, and the user can drag the image filter icon of “Autumn” out of a display area of the image filter list by continuing the dragging operation to cancel the dragging event, and a current arrangement manner of the image filter list remains same.

As another embodiment of the present invention, if a location of a first image filter icon is not in an area in which an image filter list locates, the first image filter icon is deleted from the image filter list. By using this embodiment, a user can delete a disliked or rarely used first image filter icon, so as to simplify the image filter list, and further improve image processing efficiency.

By using the foregoing method, an image filter icon can be deleted from the image filter list. For example, if a user A seldom uses a filter “Autumn” during an image processing process, an image filter icon of “Autumn” can be dragged out of a display area of the image filter list. In this way, the image filter icon of “Autumn” can be deleted from the image filter list, so as to refine image filter icons in the image filter list. The image filter list is simpler after the image filter icons are refined, and satisfies an individual requirement of a user better; and a process of loading the image filter list is quicker because the image filter list is simplified, so as to further improve operation efficiency of image processing. It should be noted that a deleting operation of an image filter icon only indicates not displaying the image filter icon in the image filter list, but not indicates deleting the filter for real. The deleted filter can be restored from a corresponding administration interface of image processing software or camera software, so as to satisfy real-time needs of the user.

In the embodiment of the present invention, a location of an image filter icon in the image filter list is changed by detecting a dragging event of the image filter icon in an image processing interface, so as to reset arrangement of the image filter list, and display image filter icons that are frequently used by the user in the front of the image filter list, which improves picture processing efficiency.

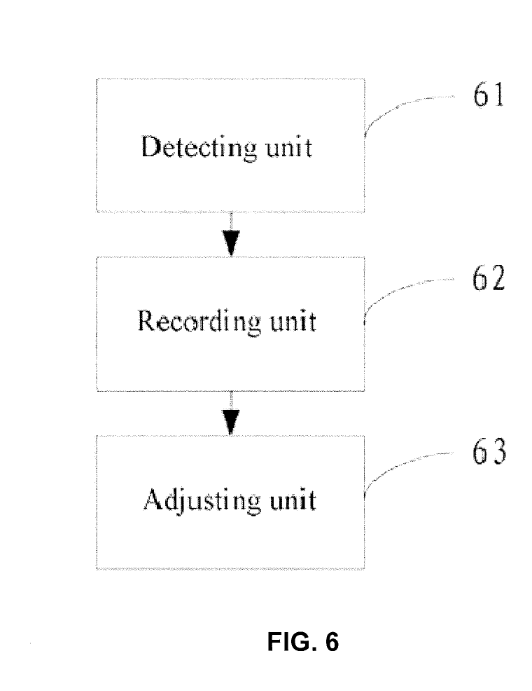

FIG. 6 is a structural block diagram of an image filter list adjusting apparatus provided by an embodiment of the present invention, and to facilitate description, only a part corresponding to this embodiment is shown.

Referring to FIG. 6, the apparatus includes a detecting unit 61, a recording unit 61 and an adjusting unit 63. The detecting unit 61 detects a triggering and moving event of a first image filter icon in an image filter list, and triggers a draggable state of the first image filter icon. The recording unit 62 detects a dragging event of the first image filter icon, and records a location of the first image filter icon when the dragging event is completed. The adjusting unit 63 adjusts arrangement of the image filter list according to the location of the first image filter icon.

Optionally, the adjusting unit 63 is specifically configured to insert the first image filter icon to the location of the first image filter icon if the location of the first image filter icon is in an area in which the image filter list locates.

Optionally, the adjusting unit 63 is specifically configured to insert the first image filter icon in front of or after a location of a second image filter icon if the location of the first image filter icon overlaps the location of the second image filter icon.

Optionally, the adjusting unit 63 is specifically configured to keep the current an image filter list unchanged if the location of the first image filter icon is not in an area in which the image filter list locates.

Optionally, the adjusting unit 63 is specifically configured to delete the first image filter icon from the image filter list if the location of the first image filter icon is not in an area in which the image filter list locates.

In the embodiment of the present invention, a location of an image filter icon in the image filter list is changed by detecting a dragging event of the image filter icon in an image processing interface, so as to reset arrangement of the image filter list, and display image filter icons that are frequently used by a user in the front of the image filter list, which improves picture processing efficiency.

The present disclosure can be implemented in any convenient form, such as dedicated hardware or a combination of dedicated hardware and software. The process of the present disclosure described above can be performed by a computer that is provided with a CPU, a ROM and a RAM that can execute a computer readable program. Because the present disclosure can be implemented as software, every aspect of the present disclosure contains computer software that can be implemented in a programmable device. The computer software can be provided to the programmable device such as a floppy disk, a hard disk, a CD ROM, a tape device or a solid state storage device, where the programmable device uses any storage medium to store processor readable code. A hardware platform includes hardware resources of any needed type, where the hardware resources include, for example, a central processing unit (CPU), a random access memory (RAM), and a hard disk drive (HDD).The CPU can be implemented by using any ideal quantity of processors of any ideal type. The method described in the present disclosure can be implemented by using only one processor. The HDD can be implemented by using any ideal type of non-transitory computer readable storage medium that can store a large amount of data, where the hardware resources include an input device, an output device or a network device according to different types of apparatuses. Alternatively, the HDD can be provided outside the apparatus as long as the HDD can be accessed. In this example, the CPU such as a cache of the CPU and the RAM can function as a physical memory or a main memory of the apparatus, and the HDD can function as a secondary memory of the apparatus.

The above descriptions are merely preferred embodiments of the present invention, and are not intended to limit the present disclosure. Any modification, equivalent replacement, or improvement made within the spirit and principle of the present disclosure shall fall within the protection scope of the present disclosure.

What is claimed is:

1. An image filter list adjusting method, comprising:
at a mobile terminal having a touchscreen, one or more processors and memory for storing programs to be executed by the one or more processors:
detecting a triggering and moving event of a first image filter icon in an image filter list on the touchscreen, triggering a draggable state of the first image filter icon based on the triggering and moving event and enlarging the first image filter icon such that it is larger than other icons in the image filter list;
detecting a dragging event of the first image filter icon, dynamically updating locations of the enlarged first image filter icon on the touchscreen, and recording a location of the first image filter icon when the dragging event is completed; and
adjusting arrangement of the image filter list according to the location of the first image filter icon when the dragging event is completed and restoring the enlarged first image filter icon to its original size.

2. The image filter list adjusting method according to claim 1, wherein the step of adjusting arrangement of the image filter list according to the location of the first image filter icon when the dragging event is completed comprises:
inserting the first image filter icon into the location of the first image filter icon if the location of the first image filter icon is in an area in which the image filter list locates when the dragging event is completed.

3. The image filter list adjusting method according to claim 2, wherein the step of inserting the first image filter icon into the location of the first image filter icon when the dragging event is completed comprises:
inserting the first image filter icon in front of or after a location of a second image filter icon if the location of the first image filter icon overlaps the location of the second image filter icon.

4. The image filter list adjusting method according to claim 1, wherein the step of adjusting arrangement of the image filter list according to the location of the first image filter icon when the dragging event is completed comprises:
keeping the image filter list unchanged if the location of the first image filter icon is not in an area in which the image filter list locates when the dragging event is completed.

5. The image filter list adjusting method according to claim 1, wherein the step of adjusting arrangement of the image filter list according to the location of the first image filter icon when the dragging event is completed comprises:
deleting the first image filter icon from the image filter list if the location of the first image filter icon is not in an area in which the image filter list locates when the dragging event is completed.

6. A mobile terminal having a touchscreen, one or more processors, memory, and a plurality of program units stored in the memory and to be executed by the one or more processors, the plurality of program units further comprising:
a detecting unit, configured to detect a triggering and moving event of a first image filter icon in an image filter list on the touchscreen, trigger a draggable state of the first image filter icon based on the triggering and moving event and enlarge the first image filter icon such that it is larger than other icons in the image filter list;
a recording unit, configured to detect a dragging event of the first image filter icon, dynamically update locations of the enlarged first image filter icon, and record a location of the first image filter icon when the dragging event is completed; and
an adjusting unit, configured to adjust arrangement of the image filter list according to the location of the first image filter icon when the dragging event is completed and restore the enlarged first image filter icon to its original size.

7. The mobile terminal according to claim 6, wherein the adjusting unit is configured to insert the first image filter icon into the location of the first image filter icon if the location of the first image filter icon is in an area in which the image filter list locates when the dragging event is completed.

8. The mobile terminal according to claim 7, wherein the adjusting unit is configured to insert the first image filter icon in front of or after a location of a second image filter icon if the location of the first image filter icon overlaps the location of the second image filter icon when the dragging event is completed.

9. The image filter list adjusting apparatus according to claim 6, wherein the adjusting unit is configured to keep the image filter list unchanged if the location of the first image filter icon is not in an area in which the image filter list locates when the dragging event is completed.

10. The image filter list adjusting apparatus according to claim 6, wherein the adjusting unit is configured to delete the first image filter icon from the image filter list if the location of the first image filter icon is not in an area in which the image filter list locates when the dragging event is completed.

11. A non-transient computer readable storage medium storing computer program units being executed by one or more processors of a mobile terminal having a touchscreen, the program units further including:
a detecting unit, configured to detect a triggering and moving event of a first image filter icon in an image filter list on the touchscreen, trigger a draggable state of the first image filter icon based on the triggering and moving event and enlarge the first image filter icon such that it is larger than other icons in the image filter list;
a recording unit, configured to detect a dragging event of the first image filter icon, dynamically update locations of the enlarged first image filter icon, and record a location of the first image filter icon when the dragging event is completed; and
an adjusting unit, configured to adjust arrangement of the image filter list according to the location of the first image filter icon when the dragging event is completed and restore the enlarged first image filter icon to its original size.

12. The non-transient computer readable storage medium according to claim 11, wherein the adjusting unit is configured to insert the first image filter icon into the location of the first image filter icon if the location of the first image filter icon is in an area in which the image filter list locates when the dragging event is completed.

13. The non-transient computer readable storage medium according to claim 12, wherein the adjusting unit is configured to insert the first image filter icon in front of or after a location of a second image filter icon if the location of the first image filter icon overlaps the location of the second image filter icon when the dragging event is completed.

14. The non-transient computer readable storage medium according to claim 11, wherein the adjusting unit is configured to keep the image filter list unchanged if the location of the first image filter icon is not in an area in which the image filter list locates when the dragging event is completed.

15. The non-transient computer readable storage medium according to claim 11, wherein the adjusting unit is configured to delete the first image filter icon from the image filter list if the location of the first image filter icon is not in an area in which the image filter list locates when the dragging event is completed.
